(19) United States
(12) Patent Application Publication
(10) Pub. No.: US 2016/0284124 A1
(43) Pub. Date: Sep. 29, 2016

(54) Three-Dimensional Visual Functional Interactivity

(71) Applicant: Kenneth Todd Riddleberger, Chesapeake, VA (US)

(72) Inventor: Kenneth Todd Riddleberger, Chesapeake, VA (US)

(21) Appl. No.: 14/544,695

(22) Filed: Mar. 23, 2015

(51) Int. Cl. G06T 19/00

(52) U.S. Cl. CPC G06T 19/00

(57) ABSTRACT

A system, method, process, technology or product comprising the symmetry, aggregate or reversed combination of realistic disruption, which is disruptive realism, wherein both are three-dimensional or said product; and wherein said product comprising; one or more realistic and disruptive functions, elements, properties or features within the same space at the same time, or resulting in the union or visual and functional approximate union, within the same space at the same time, or approximate the same space and time, having or providing said product features, functions, properties or visual and functional effects and all resulting combinations for use thereof.

### BACKGROUND OF THE INVENTION

1. Technical Field

The invention is the use and combination of any visual and functional process and means of creating, replicating, providing or displaying a product having the visual, functional and spatial relation or position, and their actions, interactions, reactions or results of visible and functional features, properties, particles, images or objects, including their graphic and electronic use and manipulation within similar or dissimilar means, portions, features, properties or products for use or use in combination, having or resulting in three-dimensional images or products having three-dimensional images.

2. Description of Related Art

N/A

### BRIEF SUMMARY OF THE INVENTION

All particles and functions derived from existence whether naturally occurring, man-made, or yet to be discovered, and their resulting combinations, comprise a visual or functional element or feature, wherein any visual or functional property may be used in singularity or by combination herein, and their resulting combinations, for use of either or both visual and functional properties, comprising, an item, object, image, media or product further comprising, the visual and functional union of a three-dimensional composition or means, and wherein used, created by design, replicated, manufactured or produced by combination, portion or entirety for use as said product. The present invention is not the particle or item itself, but the image or visual and functional properties of the particle or item having three-dimensional properties and the addition of one or more visual and functional means providing three-dimensional properties thereon, more specifically it is the implementation of function, realism, or realistic function within an image or feature, or simulation of the particle or image providing the image or simulation, with said three-dimensional features or properties, and/or their reversed realistic and functional properties and their combinations for use as said product comprising, visual and functional features being located within the same space at the same time, or approximate the same space at approximate the same time, when visible together, are three-dimensional, further the use of realistic visual and functional properties added within a two-dimensional or three-dimensional format, image, video, etc. enables features or properties to be realistically and functionally three-dimensional. Depth and light, and their use, or variances for use, of either or both, and their combined effects enhance and modify three-dimensional properties and are claimed herein, as they relate to said product or said products use, whether naturally occurring or man-made and whether simulated, artificially or graphically implemented or enhanced. One skilled in the art can realize, that light and depth, and any resulting visual or functional combination or variation of use with said product, is only a variation of said visual and functional three-dimensional combination, or said product. Energy and motion, whether naturally occurring, erratic, created, replicated or resulting in or from any new or known or unintended combination must comprise a visible or functional element or composition to interact and be visible as a feature or function, and/or be comprised of an element or composition of interaction to be a visible feature or function, and wherein all features and functions are claimed herein. Any natural or man-made phenomenon that exist, at the time it becomes visible, or is made visible, and/or is captured, recorded, imitated, or copied by means and used as an image, video, simulation, or to produce an image, or said phenomenon or a variation thereof, by portion or in entirety, and/or by any combined means, wherein comprised of or resulting in realistic and functional element, feature and function and their combinations, or said product, and wherein used or made visible and functional by portion, feature, function or in entirety, within a two-dimensional or three-dimensional format, image, product or said phenomenon, which can he altered or modified to provide said product properties by said means or process, comprising, a visual and functional element, feature or property providing or resulting in a three-dimensional variation or portions of said product for use or sale, whether intended or unintended, and all resulting combinations of individual or combined features within similar or dissimilar visual, functional, elemental, particulate, and variations of said product of a similar or dissimilar nature and composition, or any visual or functional combination, and their resulting combinations, from the aforementioned with any portion or portions of a similar or dissimilar item, object, image or process is said product as said product. More simply stated, said product is any visual or functional formation or composition of a three-dimensional nature used as a product, or resulting in said product, whether intended or unintended, wherein the visible and functional union or visible approximate union is used, manufactured for sale, implemented for use, or results in a product for use or sale. Said product alters materials, images, objects, items, videos, etc. into three-dimensional images or objects of three-dimensions having said three-dimensional pattern or image thereon, or providing the visual and functional appearance, or resulting in the combination of providing three-dimensional properties for use or sale. The present invention, is a three-dimensional image and a product having a three-dimensional image comprising, the visual and functional formation of visual and functional properties, and any or all resulting combinations of graphics, functions and visual and functional properties for use, enhancement or manipulation of similar or dissimilar features, functions, properties, elements or particles within or thereon, or by combination with a similar or dissimilar, image, video, feature, function or property, and for use of all visual or functional effects and resulting combinations, or said product. The realistic and functional properties of said product can he altered, replicated and modified by portion or feature, or in entirety and/or used, blended or morphed by color, feature, function, element or property, wherein either or both portions, having visual and functional properties, and their resulting union can be manipulated, replicated or enhanced for use or for use within any similar or dissimilar item, object or product. The resulting combination of the aforementioned, is three-dimensional, and intended for use, and capable of being added within or thereon a product, designed by combination, or be singularly or collectively visually and functionally oriented to provide features and effects, further, said visual portion and said function portion, or their combination can be modified or realistically and functionally altered to enhance or provide additional three-dimensional properties and claimed herein as said product.

### DETAILED DESCRIPTION OF THE INVENTION

A system, method, process, technology or product having or resulting in the symmetry, aggregate or reversed combination of realistic disruption, which is disruptive realism, wherein both are three-dimensional or said product, and wherein said product is used, altered, replicated, or modified by any means in portion, or in entirety to create, obtain or provide said product features and function and visual properties and their combination, wherein comprised of a pixel, element, feature, pattern, image, function, technology or means whether manipulated before, during or after and all resulting combinations. Further, a product having or resulting in the combination of said product properties comprising, a multi-image, multi-function, multi-feature, multi-pattern, multi-media or multi-camouflage pattern, or any combination of a disruptive element, feature, pattern, image, photograph, picture and a realistic element, feature, pattern, image, picture, pixilated, digitized, graphically altered or computer enhanced element, feature, pattern, image, photograph, picture, media, video, video game, electronic device, television, movie or any object or item and any and all combinations of functions of elements, features, patterns, images, pictures, objects or items comprising any single or combined use with a similar or dissimilar item, object, image, or product, providing said product visual and functional features in the same space at the same time, or approximate the same space at approximate the same time, and wherein their visual or functional union or approximate union provides three-dimensional features and effects or other three-dimensional visual and functional properties, or said product. Additionally, said product comprised of, or used within artwork, videos, objects, products or any item or feature of a two-dimensional or three-dimensional background, foreground, layer, feature, image, video, media, video game or object for their singular or combined effects and properties of said product features and functions, by any means, resulting in the combination of said visual and said functional properties for sale or use. Further comprising, substitution with a similar or dissimilar said product, for use or use in combination, for one or more users or observers or for any reason, and wherein their visual and functional properties combination as said product or feature or portion of said product can be used in isolation or combination for any use. Wherein any item or object in existence, known to have existed, or that can he created, photographed, captured, transferred, filmed, graphically simulated or which has or becomes visually or functionally viable, or their apparent use of a visual and functional nature or composition, or any unknown or unidentifiable variance or multi-variance of a visible and functional nature and composition and their combinations, can be used for visual and functional properties herein. One skilled in the art can see that a variety of combinations may result from any singular or combined effects of similar or dissimilar features having both realistic and disruptive properties. Further, use of either or both multi-visual and multi-functional said products by portion, image, feature, object, or by combination, or in entirety, can be replicated or altered or have new features or functions added thereon for any use. Further, said product can provide two visual properties within the same space at the same time, or two functional properties within the same space at the same time, wherein any single or multi-layer version or variation can visually and functionally coexist simultaneously within the same space at the same time, or approximate the same space and time within said product or features or portions of said product. Further, said feature, portion or entirety may interact, and include their interaction for use with realistic and functional spatial or negative spatial portions of depth having similar or dissimilar features and functions or other therein, and any combination or interaction of properties or effects for use alone, or with the above aforementioned or other. Further, any feature or portion of an image or item can be comprised of two-dimensional properties and additional similar or dissimilar features, functions, or properties or portions added, modified or realistically and functionally manipulated for use or use in combination with said product. Said product comprising by portion or entirety similar or dissimilar features and visual and functional properties wherein portions or entirety can exist within the same space at the same time, or visibly approximate the same space and time, which may further be designed so as to interact so as to provide any visual or functional effect, and or be used with any other visual or functional image, effect or item for use or their combined visual or functional effects, results or as desired. The visible union, or visible approximate union, can be created or designed to visually and functionally work in unison or in opposition monolithically, or created and designed to visually function by combination, comprised of separate visual and functional properties and effects. Said product features can be merged or morphed together within layers, features, images, videos etc., and can function independently or collectively, or can be edited separately to be viewed simultaneously, or by any means resulting in said product effects, including their use in providing or being produced in or by multiple portions or said products used concurrently, or for delayed, offset, stereoscopic or any combined effects or other, whether intended or unintended, resulting in the visual and functional properties or other combinations of said product. One skilled in the art can recognize that their are a variety of uses and applications for a product having said product features which are new, unique and useful and which may be desirable by consumers. Further, a user, consumer, manufacturer or observer may desire said product capabilities as an alternative to what is currently available, and wherein said product features, function and visual properties may be preferred. An item such as a television or electronic device capable of manipulating depth with mirrors, or elongating depth is not a three-dimensional image or video, the image or video has to be three-dimensional or it is an elongated or distorted two-dimensional image or video, properties establish function within an image or video, and unless the function is realistic to the property and implemented for use within the image or video then the image doesn't have three-dimensional properties, and cannot be three-dimensional unless three-dimensional visual and functional properties are added, and unless the function is similarly, or other by design, realistic and functional it will degrade the visual and functional quality, depth, function, or other features of the image or video. Wherein said product provides realistic disruption or disruptive realism within the same space and time, or visually approximate the same space, to exhibit three-dimensional properties, features or effects. The present invention comprising the use, means and process of any three-dimensional properties or products, for use or use in combination whereby, any optical, visual or functional enhancement, overlay, underlay, layer, pattern, or image processing or manipulation software or device, can modify existing properties or features and be used to produce said product features, having or resulting in the visual and functional properties of a three-dimensional composition or formation, and thereby enhancing features or functions therein, or be comprised of the visual and functional portions, means and process of said product. Further, one skilled in the art can see that any design or manipulation of said product into abstract, semi-realistic, semi-functional, unidentifiable, patterned distortion and any multiple combination thereof, by or with any visual enhancement means, process or device, whether by portion or combination, is only a visible and functional process, means or device providing a variation of said product, and wherein comprised of visual and functional features of the present invention, being either or both a visual or functional property and/or their combination. The present invention as described herein, is not a definition of the limits of the invention, wherein one skilled in the art can realize that many variations or results can arise from the visual and functional combinations and use of any various elements, functions, or visual properties and their manipulation with similar or dissimilar portions of said product or other products, wherein any resulting three-dimensional combination is acceptable for use and claimed herein, including variations or reclassification of said dimensional or multi-dimensional, elements, properties, features and functions and visual elements, properties, features, functions and/or combined effects for use as said product or as described for the purposes herein.

What I claim is:

3. A computerized system and process according to claim 1, comprising an image, video, or camouflage pattern, and their computerized or electronic equivalent, comprised of a programmable code of three-dimensional pixel or pixel group combinations, which can be used for creating, viewing, modifying and upgrading, by portion, combination, or replacement of new or prior static two-dimensional and three-dimensional images, videos, or camouflage patterns, wherein prior images, videos, or camouflage patterns having been inputted, or their computerized or electronic equivalent, having been inputted and coupled to said computerized system and process, which has been programmable configured to interpret, modify and reconfigure prior static pixel or pixel group values, by a mathematical, algorithmic, and image processing means, thereby altering or replacing prior pixel or pixel groups with a new substitute programmable three-dimensional pixel or pixel group combination, further comprising said new three-dimensional pixel or pixel group combinations can be systematically configured by design, comprised of both a visual means and a functional means, having properties that coexist simultaneously, within the spatial parameters, of one or more dimensions, of said three-dimensional pixel or pixel group combination, wherein a computerized image or video processing system having analyzed the inputted data and calculated, assigned and interpreted the prior static pixel values, provides replacement, or combination thereon, forming new geometrically visual and functional property combinations, based on one or more parameters, of one or more dimensions, within a visual and functional matrix, wherein their programmable or electronic algorithmic code having been linked to the prior image or the binary code of the prior image, video, or camouflage pattern can undergo fractal and linear zooming methods and techniques and refining processes about the prior, by the computerized means, by portion, feature or frame, wherein the computerized system and process can alter and interpret color, properties, or values, and up-grade or replace, by one or more means, providing a new substitute coded dynamic visual and functional three-dimensional pixel or pixel group combination, suitable for being outputted for use as or within an image, video or camouflage pattern as a new design or variation thereof.

4. A computerized system and process of claim 1, comprising use, method and manufacture of a computerized, electronic, or graphically automated and programmable coded multi-dimensional, multi-functional and multi-interactive three-dimensional pixel or pixel group matrix, for use as or within an image and video system process, whereby configurations can be used to create, combine, up-grade, or replace images and videos, wherein portions having been configured, or re-configured to be analyzed, modified and used by said computerized system, further comprising a prior pixel or pixel group, color block, or portion of an image or video, by portion, entirety, combination, or substitution implemented for use as an image or video, wherein design configurations, combinations, or portions can be used to produce three-dimensional pixel or pixel group variations, which can be inputted, outputted, or used as or within an image, video, media, multi-media, video game, hologram, projection, simulation, virtual display, whether created singularly, designed by combination, or result by a combined means, such as a monolithic visual and functional three-dimensional design format, or a multi-design format, having or resulting, by arrangement or combination, wherein said visual and functional portions provide both realistic and functional properties simultaneously within the same space at the same time, or visually and functionally approximate the same space and time, or at any space or time relative to their visual, functional, interactive or interchangeable coded embodiments, within one or more dimensions, of one or more layers, portions, features or frames, having, providing, or resulting in similar or dissimilar three-dimensional visual, functional, interactive, or combined pixel or pixel group portions of an image or video.

5. A computerized system and process of claim 1, comprising design and configuration of images and videos having a programmable coded three-dimensional composition, used within a computerized system and process, wherein the computerized system and process is capable of analyzing, interpreting, modifying, inputting, or outputting three-dimensional pixels or pixel groups, whether created by design, or resulting from combination, wherein portions can be programmable and receivable by portion or entirety, and wherein portions can be visible by portion or entirety, or by the process of uploading, downloading, sending, receiving, decoding, programming, viewing, displaying, or combining one or more portions together, having or resulting in one or more three-dimensional pixel or pixel group portions within an image, video, or camouflage pattern, wherein said three-dimensional pixel or pixel group combinations can be used for creating, modifying, viewing, or displaying images or videos on a device or product, wherein use by portion, combination or entirety results in a product, application, electronic, or graphic variation of a three-dimensional image or video, having three-dimensional pixel groups, of a visual and functional combination, and their digital, electronic or graphic equivalents, viewed or displayed by feature, portion, or entirety as or within images and videos, or within prior static two-dimensional or three-dimensional images or videos, wherein use can up-scale, up-grade, modify or enhance images or videos, from lower standard definition, to new higher quality definition, providing by portion or entirety coded three-dimensional image or video portions, used as or within images, videos, movies, television broadcasts, sporting events, video games, cameras, digital cameras, devices, hand held devices, phones, digital cinema, cinema, media, multi-media, and for live or real-time broadcast, online feeds, Internet, computer, graphic, archived or restorative image or video use, on or about any product, by any computerized or electronic device or means.

6. A computerized system and process of claim 1, comprising use, method and manufacture of an electronic, graphic, or computerized means and technology capable of analyzing, interpreting, restoring, rendering and providing three-dimensional visual, functional and interactive pixel or pixel group combinations, which can be used, viewed, or combined within one or more similar or dissimilar pixel or pixel groups of an image or video, wherein portions or entirety can be used, stored, processed, edited, displayed or modified on or by a camera, video camera, hand held device, smart phone, tablet, watch, ocular device, eyeglass, headset, television, or a computerized or electronic device, having or providing compatible or enhanced technology and means thereon.

7. A computerized system and process of claim 1, comprising a technology and means for designing and implementing a programmable coded three-dimensional pixel or pixel group system used for creating and modifying images and videos, and for use in up-grading, up-scaling, enhancing, modifying, altering, transforming, or replacing prior images or videos, or portions thereof, wherein pixel or pixel groups can be configured by design or combination, to provide, by feature, portion, or entirety, a new variation, substitution, or combination, wherein a prior two-dimensional or three-dimensional image, video, or pattern, can be transformed into a new three-dimensional image, video, video game, artwork, simulation, architectural, agricultural, thermal, spatial, geo-thermal, medical, sonar, ballistic, navigational, oceanic, infrared, or military simulation, or for use, and design on products or devices displaying their use thereon, wherein said three-dimensional pixel or pixel group combinations can be used for viewing, displaying, recording, or providing three-dimensional images or videos.

8. A computerized system and process of claim 1, comprising a programmable three-dimensional pixel or pixel group combination, having or providing visual and functional property combinations simultaneously, within one or more dimensions, of an image or video, for use as or within a location or destination as an outputted image or video, by portion or combination, wherein design, or use by combination, with a prior static pixel or pixel group of a designated color block of a static two-dimensional or three-dimensional image or video, can be transformed by combination or replacement, resulting or producing a new three-dimensional pixel or pixel group, wherein design can include any definable perimeter or shape, comprised of an optically enhanced visual functional internal core area, wherein the optically enhanced core portion, can extend by portion to include the perimeter of one or more, or all edges of the perimeter, comprising a three-dimensional shape or portion thereof, and wherein said internal core portion and perimeter are capable of receiving and providing visual and functional properties simultaneously, at the same time in the same space, comprised of a programmable code of three-dimensional pixels or pixel groups properties or values used in combination, or configuration by portion respectively, within one or more dimensions of said pixel or pixel group, wherein features and spatial properties having been configured by any desired parameter, comprised of portions configured by a programmable means capable of being assigned and receptive, by proximity, portion, location, or entirety to receiving a color, property, chrominance, luminance, value, visual or functional property, and their combination thereon, wherein use or combination, provides by portion or entirety, both a visual and functional combination, visible within one or more similar or dissimilar pixel or pixel groups, of a three-dimensional image or video, having one or more pixel or pixel groups which can be used interchangeably or interactively to create, replace, or for use in combination, by portion or entirety, when designing, editing, modifying, or enhancing an image, video, media, multi-media, video game, logo, artwork, or product.

9. A computerized system and process of claim 1, comprising a dynamic three-dimensional visual and functional pixel or pixel group composition, configuration, and combination, having one or more three-dimensional pixel or pixel groups, used within a programmable coded combination, within a three-dimensional construct, comprised of a three-dimensional matrix, for viewing, displaying, or producing an image or video, further comprising, said three-dimensional pixel or pixel groups combinations can be used for creating or editing new images or videos, or for replacing prior images or videos, or portions thereof, wherein said three-dimensional pixel or pixel groups, being either created by design, or their programmable computerized or electronic equivalent, providing or resulting in three-dimensional visual and functional property combinations, within one or more dimensions of an image or video, further comprising, said computerized system and process can replicate or generate the reverse or aggregate portions of the negative, or normally hidden, dimensional properties of a visual and functional composition from a two-dimensional perspective three-dimensionally, providing visible and functional properties for rotational or interactive viewing within three-dimensional parameters, having spatial and dimensional portions of a three-dimensional image within a defined geometric construct, by three-dimensional pixel or pixel group combinations, within a three-dimensional matrix used as or within an image or video respectively, wherein visible and functional portions, of either or both, a front and rearward dimensional perspective can be configured by three-dimensional pixel or pixel groups, visible within their dimensional parameters, wherein either or both perspectives providing portions which can be designed and configured of features and properties comprised of both a visual means and a functional means, within the same space at the same time, wherein portions can be dynamically three-dimensional and interactive internally, externally, and within the core area of a three dimensional pixel or pixel group configuration, wherein portions or entire pixel or pixel groups, or combinations thereof, can have one or more visual and functional dimensional properties which can extend by portion or combination for use within one or more similar or dissimilar three-dimensional pixel or pixel groups of an image or video.

10. A computerized system and process of claim 1, comprising a visual and functioning three-dimensional pixel or pixel group combination, comprised of a visual means and a functional means, wherein either or both means providing features, shape, texture, parameters, values and properties programmable and configured, and compatible for use, within a bitmap or vector format, wherein their use, design and configuration can be analyzed, interpreted, combined, or modified, by said computerized programmable process, having one or more compositional variations or means which can add, convert, alter, provide, or replace, one from the prior to the other, by portion, entirety or combination, comprising replacement, substitutions or combinations having either or both, or an interchangeable coded three-dimensional visual and functional means thereon, for use as or within one or more dimensions of a three-dimensional pixel or pixel group, used by portion or entirety as an image or video.

11. A computerized system and process of claim 1, comprising a three-dimensional pixel or pixel group, or a three-dimensional pixel or pixel group combination, configured by pixel or pixel group portions to form a three-dimensional image or video, which can be generated by a computer, electronic device or means, further comprising, said three-dimensional pixel or pixel group portions can be modified within one or more dimensions, wherein design, configuration, or result can be a visual, functional and interactive combination simultaneously, within one or more or all dimensions, of a three-dimensional pixel or pixel group, of an image or video, wherein said functional portion can be any naturally occurring, simulated or computer generated function replicating an action, reaction, interaction or motion, having or providing, a dynamic visually functional property composition therein.

12. A computerized system and process of claim 1, comprising a three-dimensional pixel or pixel group combination, wherein portions can be used, added, or combined to either or both images or videos, wherein said system having duplicated the prior source image or video, or their combination, which can be used for creating new three-dimensional images or videos, or as a replacement portion thereof, wherein their union, or resulting visual and functional approximate union, having visual and functional properties of both, combined in a mutually intrinsic union, comprised of there-dimensional pixel or pixel group portions, which can be used to replicate features or portions in multiples, providing dynamic, multi-dimensional, multi-functional, multi-interactive, and multi-visual features therein, comprising use by said computerized system and process, having software and an algorithmic process using at least one processor; a memory storage, and a computer readable medium that is compatible by the at least one processor, which is operatively coupled to the memory storage, wherein, the computer readable medium having stored thereon a sequence of instructions that, when executed by the at least one processor, causes the execution of the steps of replicating each respective pixel or pixel groups of the frame or portion of the source image or video; designated to be duplicated, enhanced, up-scaled, or up-graded by having analyzed the prior image or video properties by fractal, vector, linear zooming, by one or more steps of each individual source pixel, pixel group, portion or frame, of the respective frame or portion, and generating a single or plurality of proposed replacement three-dimensional pixel or pixel group portions, or combinations, for use, to replace, or for combination with source image or video, pixel group, portion or frame, for creating new designed output images or videos, by portion or entirety, wherein the new three-dimensional pixel, pixel group, portion or frame having a number of proposed replacement three-dimensional pixel or pixel group portions or frames is based on a programmable algorithmic code compatible and formatted for use within a computerized system providing three-dimensional images or videos, which can be up-graded, altered or used in combination to provide, a substitute, by portion, combination, or entirety, wherein substitution or use provides a new outputted image or video, or portions thereof, having three-dimensional pixel or pixel groups, which can be visual and functionally combined, or programmed to interact within dimensional parameters, within one or more, or all dimensions by feature, portion or entirety, having or providing new multi-dimensional, multi-functional, and multi-interactive foregrounds, layers, backgrounds, or overlays within similar or dissimilar-three-dimensional features and properties of an image or video.

13. A computerized system and process of claim 1, comprising a three-dimensional pixel or pixel group combination, used within an image or video, wherein portions can be automated by a computerized, electronic, or programmable means which can perform, one or more steps automatically in inputting, analyzing, editing, modifying, up-grading, up-scaling, providing, displaying, recording, combining, saving, or outputting properties, for a new design, or for use by combination within a prior image or video, resulting by portion or combination in an image or video, having three-dimensional pixel or pixel group configurations thereon.

14. A computerized system and process of claim 1, comprising the computerized system and process using the method and step of analyzing an image or video, having had a prior image or video in-putted into the computerized system by any means, and wherein software is designed to interpret and determine whether the prior image or video has three-dimensional image or video content, or three-dimensional pixel or pixel group combinations thereon, wherein portions being automated by a computerized means and electronic means, wherein the computerized means and electronic means performs one more steps simultaneously, in the process of analyzing and combining, displaying, up-scaling, up-grading, filtering, refining, deleting, replacing, or combining portions from either a prior static two-dimensional or three-dimensional image or video, or a prior dynamic three-dimensional image or video, into a proposed new design and outputting them for use as a new three-dimensional image or video.

15. A computerized system and process of claim 1, comprising a three-dimensional pixel or pixel group combination, having portions automated and implemented for use by a computerized or electronic means utilizing a computerized image processing system, wherein said system performs: a series of steps in analyzing, creating, or replacing prior pixel or pixel group portions, properties, or values, of a prior two or three-dimensional image or video, and wherein said means combines, modifies, or generates proposed new replacement pixel or pixel group portions, by having analyzed portions, features and frames by parameters of color, texture, chrominance, luminance, property, or value, wherein each proposed frame of a prior pixel or pixel group, or color block, of a feature or frame within an image or video, is altered by image, editing and filtering processes to provide new three-dimensional pixel or pixel group portions, of an image or video, which can be used as a new up-scaled and up-graded version of the prior original two-dimensional or three-dimensional source image or video, having new three-dimensional visual and functional elements, features, or properties, used as a final desired outputted image or video.

16. A computerized system and process of claim 1, comprising a three-dimensional pixel or pixel group combination, wherein portions can be automated, configured and programmed to perform one or more steps used to create, analyze, up-grade, up-scale, combine, display, or replace a prior pixel or pixel group portion of an image or video, having been linked to the prior image or video within a computerized system, wherein the image or video having been inputted, analyzed, combined, modified or designated for replacement, wherein steps can be executed by the computerized system, to transform one or more pixel or pixel group portions of the inputted corresponding image or video, wherein a new proposed replacement three-dimensional pixel or pixel group portions can be used, or used by combination within an image or video, wherein if a lower or higher resolution is desired for final pixel or pixel groups of an image or video, the resolution of the pixel or pixel group can be adjusted, up-graded, or modified by pixel or pixel group portions, or by entirety, within the three-dimensional image or video.

17. A computerized system and process of claim 1, comprising one or more three-dimensional pixel or pixel group combinations, configured for use within a monolithic format, or multi-design format, used for creating or displaying, new three-dimensional images, videos, or video games, and for use in upgrading prior image, video or video games, for use on an image, video, or video gaming system, or an electronic or computerized technology or device, wherein image, video, video game, or portions thereof, can be in-putted, outputted, uploaded, downloaded, transferred, viewed, or printed by said computerized system and process for use.

18. A computerized system and process of claim 1, comprising software and an algorithmic means which can be used to create, or enhance, one or more pixel or pixel groups, used within an image or video, wherein portions can be automated and in-putted, implemented, executed, modified, and out-putted by said computerized system and process, wherein portions programmable configured and capable of receiving instructions simultaneously, by having been linked by properties, features, values, or portions, comprised of portions used by said system providing a new functional or visual property, or their combination therein, which can be modified, interchanged, or added within one or more dimensions, of a prior two-dimensional or three-dimensional image or video, wherein said system implements a three-dimensional pixel or pixel group therein, by portion or entirety, within an image or video respectively, within one or more dimensions, which include either or both a new visual or a new functional property, or their combination, added to an image or video by said computerized system and process.

19. A computerized system and process of claim 1, comprising a method and means for creating, designing, displaying, and upgrading images and videos by three-dimensional pixel or pixel group portions, having visual, functional, and interactive pixel or pixel group portions, or combinations, which can be automated and implemented by a computerized or electronic process and means, wherein said system and process configures said pixel or pixel group portions, comprised of features, properties, or elements, having a functional means and a visual means, or their combination, configured by parameters, within one or more dimensions, used within a three-dimensional pixel or pixel group, configuration, wherein a pixel or pixel group combination, can be used to design or create a new image or video, and for use by combination, or replacement, with a prior two-dimensional or three dimensional image or video, wherein portions or entirety, can have both visual and functional properties simultaneously, within one or more dimensions, of a three-dimensional pixel or pixel group configuration, comprised of a shape, design, or format modified, integrated, or implemented by one or more means, for use as or within a three-dimensional image or video.

20. A computerized system and process of claim 1, comprising, one or more images, videos, or camouflage patterns, or their computerized or electronic equivalent, comprised of visual and functional features, properties, elements, or particles having or being used within one or more three-dimensional pixel or pixel group combinations, automated, implemented, or displayed, by one or more computerized, electronic or programmable technologies, having or providing, one or more visual and functional combinations, used within one or more dimensions, of one or more three-dimensional pixel or pixel group configurations, on one or more devices, by one or more users, singularly, or by combination to create, display, view, enhance, or for use or interaction, with images, videos, or camouflage patterns thereon.
